(19) United States
(12) Patent Application Publication
(10) Pub. No.: US 2013/0244151 A1
(43) Pub. Date: Sep. 19, 2013

(54) Chemical Toner Including A Robust Resin For Solvent-Free Emulsification

(71) Applicants: Allan K. Chen, Oakville (CA); Santiago Faucher, Oakville (CA); Guerino G. Sacripante, Oakville (CA); Shigang S. Qiu, Toronto (CA)

(72) Inventors: Allan K. Chen, Oakville (CA); Santiago Faucher, Oakville (CA); Guerino G. Sacripante, Oakville (CA); Shigang S. Qiu, Toronto (CA)

(73) Assignee: Xerox Corporation

(21) Appl. No.: 13/423,820

(22) Filed: Mar. 19, 2012

(51) Int. Cl. G03G 9/08; G03G 9/093; G03G 9/16

(52) U.S. Cl. 430/105; 430/137.14; 430/137.11

(57) ABSTRACT

A toner comprising a branched polyester suitable for use in solvent-free emulsification, the branched polyester having a first original weight average molecular weight before undergoing solvent-free emulsification and a second weight average molecular weight after undergoing solvent-free emulsification, wherein the branched polyester has a structure that limits degradation of the polyester during solvent-free emulsification to less than about 20 percent of the first original weight average molecular weight, wherein the branched polyester comprises a compound of the formula described; an optional wax, and an optional colorant.

### RELATED APPLICATIONS

Commonly assigned U.S. patent application Ser. No. ______ (not yet assigned, Attorney Docket number 20110204-US-NP, entitled “Robust Resin For Solvent-Free Emulsification”), of Santiago Faucher, Guerino Sacripante, Shigang S. Qiu, Allan K. Chen, and Jordan H. Wosnick, filed concurrently herewith, is hereby incorporated by reference herein in its entirety.

### BACKGROUND

Disclosed herein are toners, and particularly emulsion aggregation toners. The toners exhibit a low melt temperature. More particularly, disclosed herein is a toner containing a robust branched polyester resin for solvent-free emulsification. The robust branched polyester resin exhibits little to no degradation in solvent-free emulsification processes. The branched polyester contains at least one of alcohol-derived branching sites or acid-derived branching sites that limit or prevent altogether degradation of the polyester during solvent-free emulsification processes such that the polyester exhibits less than about 20 percent molecular weight degradation following solvent-free emulsification. Further disclosed is a toner process for preparing a toner with the robust branched polyester.

Numerous processes are within the purview of those skilled in the art for the preparation of toners. Emulsion aggregation (EA) is one such method. Emulsion aggregation toners may be used in forming print and/or xerographic images. Emulsion aggregation techniques may involve the formation of an emulsion latex of the resin particles by heating the resin, using a batch or semi-continuous emulsion polymerization, as disclosed in, for example, U.S. Pat. No. 5,853,943, which is hereby incorporated by reference herein in its entirety. Other examples of emulsion/aggregation/coalescing processes for the preparation of toners are illustrated in U.S. Pat. Nos. 5,278,020, 5,290,654, 5,302,486, 5,308,734, 5,344,738, 5,346,797, 5,348,832, 5,364,729, 5,366,841, 5,370,963, 5,403,693, 5,405,728, 5,418,108, 5,496,676, 5,501,935, 5,527,658, 5,585,215, 5,650,255, 5,650,256, 5,723,253, 5,744,520, 5,763,133, 5,766,818, 5,747,215, 5,804,349, 5,827,633, 5,840,462, 5,853,944, 5,869,215, 5,863,698, 5,902,710, 5,910,387, 5,916,725, 5,919,595, 5,925,488, 5,977,210, 5,994,020, and U.S. Patent Publication 2008/0107989, the disclosures of each of where are hereby incorporated by reference herein in their entireties.

Polyester toners exhibiting low melt properties have been prepared utilizing amorphous and crystalline polyester resins as illustrated, for example, in U.S. Patent Publication 2008/0153027, which is hereby incorporated by reference herein in its entirety.

Polyester toners have been prepared using polyester resins to achieve low melt behavior, enabling faster print speeds and lower energy consumption. However, the incorporation of these polyesters into the toner requires that they first be formulated into latex emulsions prepared by solvent containing processes, for example, solvent flash emulsification and/or solvent-based phase inversion emulsification. In both cases, large amounts of organic solvents such as ketones or alcohols have been used to dissolve the resins, which may require subsequent energy intensive distillation to form the latexes, and may require the removal of residual solvent from waste waters in the toner making process. These processes are thus less environmentally friendly than solventless latex production processes. Solventless latex emulsions have been formed in either a batch or extrusion process through the additional of a neutralizing solution, a surfactant solution, and water to a thermally softened resin, as illustrated, for example, in U.S. Patent Publication 2009/0208864, which is hereby incorporated by reference herein in its entirety, and U.S. Patent Publication 2009/0246680, which is hereby incorporated by reference herein in its entirety.

U.S. Patent Publication 2011/0027710, of Santiago Faucher, et al., entitled “Self Emulsifying Granules And Process For The Preparation Of Emulsions Therefrom,” which is hereby incorporated by reference herein in its entirety, describes in the Abstract thereof a process for making a self-emulsifying granule suitable for use in forming latex emulsions including contacting a resin with a solid or highly concentrated surfactant, a solid neutralization agent and water in the absence of an organic solvent to form a mixture, melt mixing the mixture, and forming self-emulsifying granules of the melt mixed mixture. Self-emulsifying granules are also provided and configured to form a latex emulsion when added to water, which may then be utilized to form a toner. See also U.S. Patent Publication 2011/0028570, of Santiago Faucher, et al., entitled “Self Emulsifying Granules And Process For The Preparation Of Emulsions Therefrom,” which is hereby incorporated by reference herein in its entirety.

U.S. patent application Ser. No. 13/014,028, of Allan K. Chen, et al., entitled “Solvent-Free Toner Processes,” which is hereby incorporated by reference herein in its entirety, describes in the Abstract thereof processes for producing toners. In embodiments, alkyl or alkyl ether sulfates are used in a solvent-free toner production process as surfactants to provide for higher parent particle charge without adversely affecting particle size, distribution control and circularity of the toner particles. The disclosure also provides a new formulation and process for the emulsification of polyester resins to form nano-scale particles dispersed in water (latex) without the use of organic solvents by an extrusion process.

Certain toners, such as certain ultra low melt emulsion aggregation toners, typically contain three types of polyester resins (high molecular weight amorphous polyester, low molecular weight amorphous polyester, and crystalline polyester). To prepare this type of toner, each resin is first emulsified into an aqueous dispersion or emulsion (latex). In the toner aggregation-coalescence process, polyester latexes are combined with wax dispersion and pigment dispersion into pre-aggregated toner particles by the addition of flocculent and homogenization at room temperature. Then, the aggregation step is carried out, typically at around 40° C. for particle growth, followed by coalescence at elevated temperature. The large number of resins used in the toner can add complexity and cost to the production of the toner. Segregated storage of the various latexes can be required as well as the use of metering technology to ensure that the proper ratio of dispersions is used in the toner formulation. Further, not all resins can be successfully dispersed by a solvent-free emulsification process. For example, certain high molecular weight resins cannot be dispersed by solvent-free emulsification without suffering from heavy degradation.

What is needed is a toner that can be prepared using a reduced number of resin dispersions so as to reduce production complexity, improve product reproducibility, and reduce cost. What is further needed is a toner that can be prepared with a resin that can be dispersed by a solvent-free emulsification process. What is further needed is a toner including a resin that can be dispersed by a solvent-free process while exhibiting reduced degradation than currently used high molecular weight resins. What is further needed is a toner produced from a solvent-free hybrid resin that provides a much lower cost than toners produced from two resins by solvent-based phase inversion emulsification processes.

The appropriate components and process aspects of each of the foregoing U.S. patents and Patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is a toner comprising a branched polyester having a first original weight average molecular weight before undergoing solvent-free emulsification and a second weight average molecular weight after undergoing solvent-free emulsification, wherein the branched polyester has a structure that limits degradation of the polyester during solvent-free emulsification to less than about 20 percent of the first original weight average molecular weight, wherein the polyester comprises a compound of the formula:

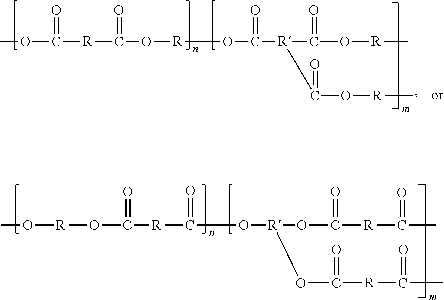

wherein R is an alkylene group, wherein the alkylene group can be selected from linear and branched, saturated and unsaturated, cyclic and acyclic, and substituted and unsubstituted alkylene groups, and wherein heteroatoms either may or may not be present in the alkylene group;

wherein R′ is an alkylene group, wherein the alkylene group can be selected from linear and branched, saturated and unsaturated, cyclic and acyclic, and substituted and unsubstituted alkylene groups, and wherein heteroatoms either may or may not be present in the alkylene group;

wherein all carbonyl carbons adjacent to R′ are separated by at least two atoms if the two atoms are separated by a single bond; or

wherein all carbonyl carbons adjacent to R′ are separated by at least 3 atoms covalently linked in series;

wherein m is an integer from about 1 to about 1,000; and

wherein n is an integer from about 1 to about 1,000;
an optional wax; and
an optional colorant.

Further described is a toner process comprising providing an aqueous emulsion comprising a branched polyester suitable for use in solvent-free emulsification, the branched polyester having a first original weight average molecular weight before undergoing solvent-free emulsification and a second weight average molecular weight after undergoing solvent-free emulsification, wherein the branched polyester has a structure that limits degradation of the polyester during solvent-free emulsification to less than about 20 percent of the first original weight average molecular weight, wherein the polyester comprises a compound of the formula:

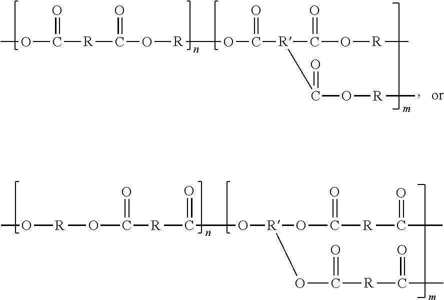

wherein R is an alkylene group, wherein the alkylene group can be selected from linear and branched, saturated and unsaturated, cyclic and acyclic, and substituted and unsubstituted alkylene groups, and wherein heteroatoms either may or may not be present in the alkylene group;

wherein R′ is an alkylene group, wherein the alkylene group can be selected from linear and branched, saturated and unsaturated, cyclic and acyclic, and substituted and unsubstituted alkylene groups, and wherein heteroatoms either may or may not be present in the alkylene group;

wherein all carbonyl carbons adjacent to R′ are separated by at least two atoms if the two atoms are separated by a single bond; or

wherein all carbonyl carbons adjacent to R′ are separated by at least 3 atoms covalently linked in series;

wherein m is an integer from about 1 to about 1,000; and

wherein n is an integer from about 1 to about 1,000; and

aggregating toner particles from the aqueous emulsion.

### BRIEF DESCRIPTION OF THE DRAWINGS

FIG. 1 is a graph showing particle size distribution for a comparative toner.

FIG. 2 is a graph showing particle size distribution for a toner prepared in accordance with the present disclosure.

### DETAILED DESCRIPTION

The toner particle described herein is prepared with a robust hybrid resin suitable for solvent-free emulsification processes. In embodiments, a toner is provided that includes a single hybrid amorphous resin which substitutes for both the high molecular weight amorphous resin and low molecular weight amorphous resin used in previous toner designs. The present toner provides a similar particle size and a similar grain size distribution as previous toner requiring more than one amorphous resin.

In embodiments, the toner particles herein comprising the robust hybrid resin in lieu of the two amorphous resins behave similarly to previous toner requiring more than one amorphous resin during aggregation, shell addition, freezing, and temperature profile. Further, the toner particles herein enable lower coalescence temperatures over previous toner which is a process advantage and reduces emulsion aggregation process cycle time. In addition, as a result of the lower coalescence temperature possible with the present toner, no quenching was necessary since the emulsion aggregation process never exceeded the melting temperatures of the wax and crystalline resins in the toner particles. This provides a further advantage from a production perspective.

In embodiments, the toners herein are low melt or ultra low melt toners. A low melt or ultra low melt toner typically has a glass transition temperature of from about 45° C. to about 85° C., or from about 50° C. to about 65° C., or from about 50° C. to about 60° C. The toners exhibit a desirably low fixing or fusing temperature. For example, the toners exhibit a minimum fusing temperature of from about 75° C. to about 150° C., or from about 80° C. to about 150° C., or from about 90° C. to about 130° C. Low melt characteristics are desirable for enabling the toner to be fixed or fused onto an image receiving substrate, such as paper, at a lower temperature, which can result in energy savings as well as increased device speed.

In embodiments, the toner includes a branched polyester that is suitable for use in solvent-free emulsification processes, wherein the branched polyester contains at least one of alcohol-derived branching sites or acid-derived branching sites that limit or prevent altogether degradation of the polyester during solvent-free emulsification processes such that the polyester resin exhibits less than about 20 percent molecular weight degradation following solvent-free emulsification, less than about 15 percent molecular weight degradation following solvent-free emulsification, less than about 12 percent molecular weight degradation following solvent-free emulsification, or is essentially free of molecular weight degradation following solvent-free emulsification.

Weight average molecular weight is a common term in the art of polymer science that describes the molecular weight of a polymer. Weight average molecular weight refers to an average that is weighted by mass rather than number. See, http://web.mst.edu/˜wlf/mw/definitions.html. Also, see http://en.wikipedia.org/wiki/Molar_mass_distribution#Weight_average_molecular_weight. For example, weight average molecular weight can be calculated by the formula

$${M}_{w} = \frac{{\sum }_{i} {N}_{i} {M}_{i}^{2}}{{\sum }_{i} {N}_{i} {M}_{i}} \begin{matrix}= \\ =\end{matrix} \frac{{\sum }_{i} {w}_{i} {M}_{i}}{{\sum }_{i} {w}_{i}}$$

wherein M_{w} is weight average molecular weight, Nᵢ is the number of molecules of molecular weight Mᵢ. Weight average molecular weight can be determined by a number of methods as is known in the art including light scattering, small angle neutron scattering, X-ray scattering, and sedimentation velocity.

In embodiments, the toner includes a branched polyester having a first original weight average molecular weight before undergoing solvent-free emulsification and a second weight average molecular weight after undergoing solvent-free emulsification, wherein the branched polyester has a structure that limits degradation of the polyester during solvent-free emulsification to less than about 20 percent of the first original weight average molecular weight, wherein the polyester comprises a compound of the formula:

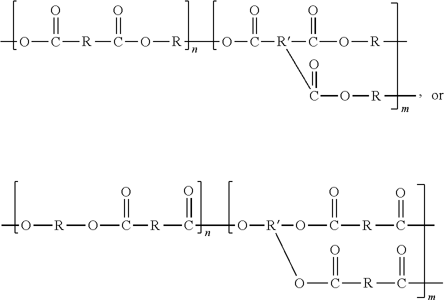

wherein R is an alkylene group (wherein an alkylene group is defined as a divalent aliphatic group or alkyl group, and wherein the alkylene group can be selected from linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group), having from about 1 to about 100 carbon atoms, or from about 1 to about 50 carbon atoms, or from about 1 to about 12 carbon atoms, although the number of carbon atoms can be outside of these ranges;

wherein R′ is an alkylene group (wherein an alkylene group is defined as a divalent aliphatic group or alkyl group, and wherein the alkylene group can be selected from linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group), having from about 1 to about 100 carbon atoms, or from about 1 to about 50 carbon atoms, or from about 1 to about 12 carbon atoms, although the number of carbon atoms can be outside of these ranges;

wherein all carbonyl carbons adjacent to R′ are separated by at least two atoms if the two atoms are separated by a single bond; or

wherein all carbonyl carbons adjacent to R′ are separated by at least 3 atoms covalently linked in series;

wherein m is an integer from about 1 to about 1,000; and

wherein n is an integer from about 1 to about 1,000.

The branched polyester can be prepared by a process comprising contacting at least one branching agent with at least one diacid, at least one diester, or a mixture or combination thereof, and reacting same to produce a branched polyester; wherein the at least one branching agent is sufficient to provide at least one of alcohol-derived branching sites or acid-derived branching sites to the polyester that limit or prevent altogether degradation of the polyester during solvent-free emulsification processes such that the branched polyester exhibits less than about 20 percent molecular weight degradation following solvent-free emulsification.

In embodiments, the toner can be prepared using a polyester latex that is prepared using a solvent-free emulsification process comprising contacting a branched polyester with a solid neutralizing agent in the absence of an organic solvent to form a pre-blend mixture; melt mixing the mixture; contacting the melt mixed mixture with deionized water to form an oil in water emulsion; optionally, recovering polyester latex particles; wherein the branched polyester contains at least one of alcohol-derived branching sites or acid-derived branching sites that limit or prevent altogether degradation of the branched polyester during solvent-free emulsification processes such that the branched polyester exhibits less than about 20 percent weight average molecular weight degradation following solvent-free emulsification.

In embodiments, the toner herein can be prepared using a polyester latex prepared by a solvent-free emulsification process comprising contacting a branched polyester with a solid neutralizing agent in the absence of an organic solvent to form a pre-blend mixture; melt mixing the mixture; contacting the melt mixed mixture with deionized water to form an oil in water emulsion; optionally, recovering polyester latex particles; wherein the branched polyester contains at least one of alcohol-derived branching sites or acid-derived branching sites that limit or prevent altogether degradation of the branched polyester during solvent-free emulsification processes such that the branched polyester exhibits less than about 20 percent weight average molecular weight degradation following solvent-free emulsification.

As used herein, “the absence of an organic solvent” means that organic solvents are not used to dissolve the resin or neutralizing agent for emulsification. However, it is understood that minor amounts of such solvents may be present in such resins as a consequence of their use in the process of forming the resin.

Branching Agents.

In embodiments, the branched polyester herein contains alcohol-derived branching sites that limit or prevent altogether degradation of the polyester during solvent-free emulsification. In embodiments, the branched polyester herein is prepared using polyols as branching monomers, in embodiments, using polyols having three or more —OH groups as branching monomers. In certain embodiments, the branched polyester contains three or more alcohol-derived branching sites.

Previously, such polyester resins were prepared using certain poly-acids as branching monomers that resulted in carbonyl carbons in the polyester backbone being separated by less than two atoms covalently linked by single bonds or that resulted in carbonyl carbons in the polyester backbone being separated by less than three atoms covalently linked by at least one double bond. Problematically, these previous polyesters are known to degrade when subjected to solvent-free emulsification processes. When certain poly-acids are used as branching monomers, two ester linkages are adjacent to one another in the backbone of the polymer. Once one of the ester linkages has been hydrolyzed, it can participate in a co-operative hydrolysis reaction that makes the second hydrolysis much faster.

Degradation of polyester resins during solvent-free emulsification processes can be problematic. In embodiments, a solvent-free emulsification process can include feeding a polyester resin and a base (such as NaOH) as powders into an extruder using gravimetric feeders. In the extruder, these materials melt mix up to the point where a surfactant solution is added. The solution mixes with the molten polymer to form a water-in-oil dispersion. The base neutralizes acid end groups on the polyester to form anionic species that help stabilize this emulsion. The surfactant further provides stabilization of the emulsion. Upon the addition of more water, the water-in-oil emulsion inverts to an oil-in-water emulsion (polyester resin in water latex/dispersion). This latex material exits the extruder die and is collected for later use which can include any suitable or desired application including, but not limited to, use in preparing emulsion aggregation toners. While the base is needed for the emulsification to proceed, the base can, as a side effect, work to degrade the resin. The present inventors have found that branched resins that use certain triacids are highly susceptible to degradation. The present inventors have discovered that the use of poly-acids that result in carbonyl carbons in the polyester backbone being separated by less than two atoms covalently linked by single bonds or that result in carbonyl carbons in the polyester backbone being separated by less than three atoms covalently linked by at least one double bond create the potential for co-operative hydrolysis reactions that makes the degradation process much faster.

In embodiments, the polyester herein contains acid-derived branching sites that limit or prevent altogether degradation of the polyester during solvent-free emulsification. In such embodiments, acid branching agents are selected wherein the acid groups are far enough apart to prevent or eliminate altogether undesired neighboring group reactions. In embodiments, the acid branching agents are selected from the group consisting of tri-acids, tetra-acids, and the like, wherein the acid groups are sufficiently far apart to prevent or eliminate altogether undesired neighboring group reactions.

In embodiments, branching is by preparing the branched polyester with an acid monomer having three or more carboxylic acid groups.

In embodiments, branching is achieved by preparing the branched polyester with an acid monomer selected from the group consisting of trimesic acid, biphenyl-3,4′,5-tricarboxylic acid, 1,3,5-trimethylcyclohexane-1,3,5-tricarboxylic acid, cyclohexane-1,3,5-tricarboxylic acid, biphenyl-3,3′,5,5′-tetracarboxylic acid, citric acid, tricarboxylic acid, butanetricarboxylic acid, nitrilotriacetic acid, and mixtures and combinations thereof.

In other embodiments, the polyester resin herein contains both acid-derived branching sites and alcohol-derived branching sites that limit or prevent altogether degradation of the polyester during solvent-free emulsification processes.

In embodiments, the branched polyester contains acid-derived branching sites that limit or prevent altogether degradation of the polyester during solvent-free emulsification processes; wherein the branched polyester contains alcohol-derived branching sites that limit or prevent altogether degradation of the polyester during solvent-free emulsification processes; or wherein the branched polyester contains a combination of acid-derived branching sites and alcohol-derived branching sites that limit or prevent altogether degradation of the polyester during solvent-free emulsification processes.

Therefore, a novel branched polyester is provided, in embodiments, for use in latex preparation by solvent-free emulsification wherein the branched polyester contains alcohol-derived branching sites that limit the degradation of the polyester during the solvent-free emulsification process, acid-derived branching sites that limit the degradation of the polyester during the solvent-free emulsification process, or a combination of alcohol-derived and acid-derived branching sites that limit the degradation of the polyester during the solvent-free emulsification process.

In embodiments, the branched polyester resin is a compound of the formula described hereinabove.

In certain embodiments, the branched polyester resin is a compound of the formula

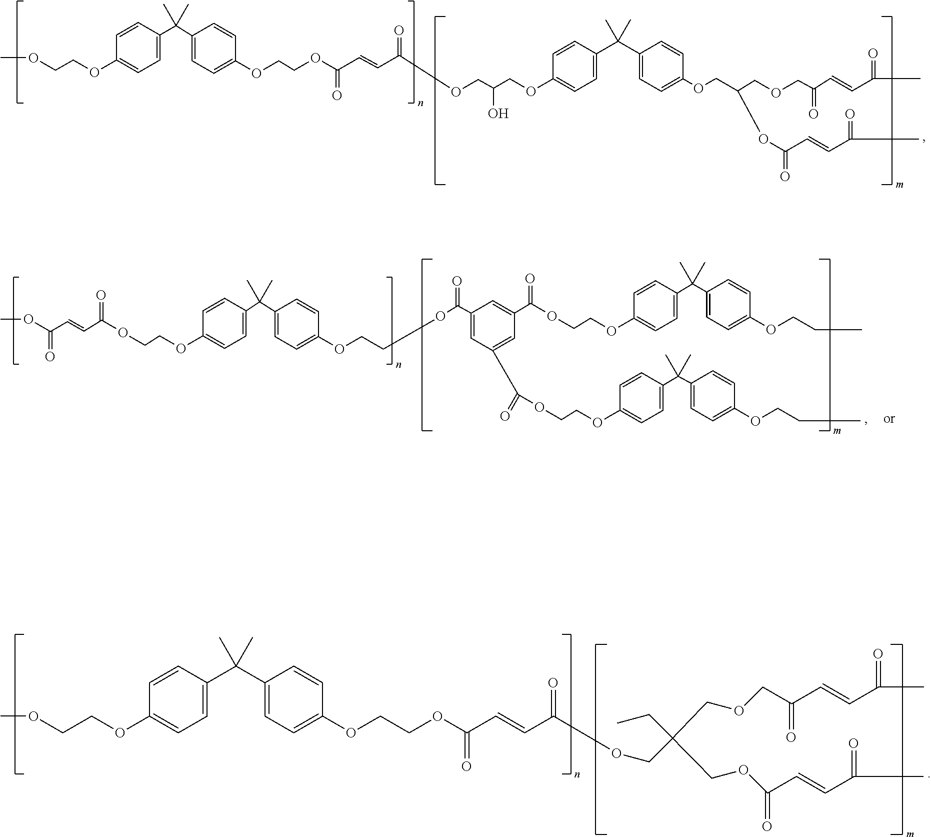

In embodiments, the branched polyester contains branching sites derived from an alcohol branching monomer having three or more hydroxyl groups.

In embodiments, the branched polyester herein is prepared using a polyol branching agent. In embodiments, the polyol branching agent is a branching monomer having three or more alcohol branching sites, that is, three or more —OH groups. In embodiments, a branched polyester is provided wherein the branching monomer is glycoxylated bisphenol A. In embodiments, the alcoholic branching sites in the polyester resin are derived from glycoxylated bisphenol-A, glycerine-modified bisphenol-A derivatives, glycerine, pentaerythritol, trimethylolpropane, mannitol, sorbitol, xylitol, glucose, fructose, sucrose, and mixtures and combinations thereof; and the polyester resin contains a portion derived from a diacid or diester selected from the group consisting of terephthalic acid, phthalic acid, isophthalic acid, fumaric acid, trimellitic acid, dimethylfumarate, dimethylitaconate, cis-1,4-diacetoxy-2-butene, diethyl fumarate, diethyl maleate, maleic acid, succinic acid, itaconic acid, succinic anhydride, dodecylsuccinic acid, dodecylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and mixtures and combinations thereof.

In embodiments, the branching agent can be prepared from the reaction of glycerine carbonate and bisphenol-A in the presence of a potassium carbonate catalyst as per Scheme 1, below.

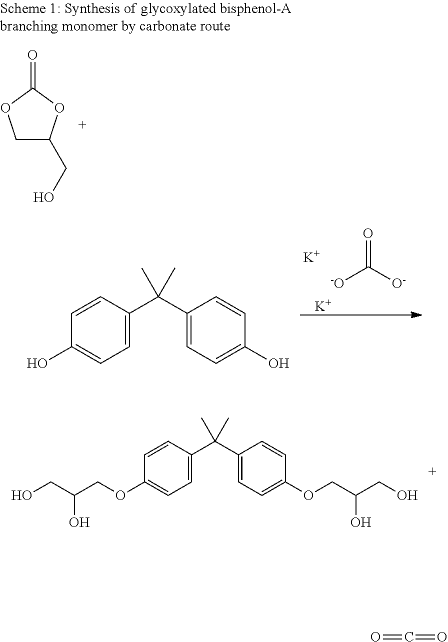

In specific embodiments, the alcoholic branching monomers herein can be selected from the group consisting of glycoxylated bisphenol-A, glycerine-modified bisphenol-A derivatives, glycerine, pentaerythritol, trimethylolpropane, mannitol, sorbitol, xylitol, glucose, fructose, sucrose, and mixtures and combinations thereof.

In embodiments, propoxylated bisphenol-A and ethoxylated bisphenol-A can be prepared from propylene carbonate and ethylene carbonate, respectively, using the carbonate route outlined in Scheme 1.

Robust Resin Prepared with Branching Monomer.

The robust branched polyester resin herein can be prepared by any suitable or desired method. In embodiments, the robust branched polyester herein can be prepared by combining one or more branching monomers with one or more diesters or diacids in the presence of an optional catalyst to produce a branched polyester containing a portion derived from a diacid or diester. In embodiments, the branched polyester contains a portion derived from a diacid or diester selected from the group consisting of terephthalic acid, phthalic acid, isophthalic acid, fumaric acid, trimellitic acid, dimethylfumarate, dimethylitaconate, cis-1,4-diacetoxy-2-butene, diethyl fumarate, diethyl maleate, maleic acid, succinic acid, itaconic acid, succinic anhydride, dodecylsuccinic acid, dodecylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and mixtures and combinations thereof.

In embodiments, a process for preparing a polyester resin suitable for use in solvent-free emulsification processes, wherein the polyester resin contains at least one of alcohol-derived branching sites or acid-derived branching sites that limit or prevent altogether degradation of the polyester during solvent-free emulsification processes such that the polyester resin exhibits less than about 20 percent molecular weight degradation following solvent-free emulsification, comprises contacting at least one branching agent with at least one diacid, at least one diester, or a mixture or combination thereof, and reacting same to produce a polyester resin; wherein the at least one branching agent is sufficient to provide at least one of alcohol-derived branching sites or acid-derived branching sites to the polyester resin that limit or prevent altogether degradation of the polyester during solvent-free emulsification processes such that the polyester resin exhibits less than about 20 percent molecular weight degradation following solvent-free emulsification.

As described herein, the branching agent can contain alcohol branching sites that limit or prevent altogether degradation of the polyester during solvent-free emulsification processes, in embodiments, the branching agent can contain three or more alcohol branching sites.

Resin Monomers.

In embodiments, the toner includes the robust hybrid resin described herein. In further embodiments, any suitable or desired additional resin monomers can be used in the processes herein. In embodiments, the toner resin can be an amorphous resin, a crystalline resin, or a mixture or combination thereof. In further embodiments, the resin can be a polyester resin, including the resins described in U.S. Pat. No. 6,593,049 and U.S. Pat. No. 6,756,176, which are each hereby incorporated by reference herein in their entireties. Suitable resins can also include a mixture of an amorphous polyester resin and a crystalline polyester resin as described in U.S. Pat. No. 6,830,860, which is hereby incorporated by reference herein in its entirety.

For forming a crystalline polyester, one or more polyol branching monomers as described above can be reacted with a diacid in the presence of an optional catalyst and a further organic diol suitable for forming the crystalline resin including aliphatic diols having from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol, and mixtures and combinations thereof, including their structural isomers. The aliphatic diol may be present in any suitable or desired amount, such as from about 25 to about 60 mole percent, or from about 25 to about 55 mole percent, or from about 25 to about 53 mole percent of the resin. In embodiments, a third diol can be selected from the above-described diols in an amount of from about 0 to about 25 mole percent, or from about 1 to about 10 mole percent of the resin.

Examples of organic diacids or diesters including vinyl diacids or vinyl diesters that can be selected for the preparation of the robust crystalline resin herein include oxalic acid, succinic acid, glutaric acid, adipic acid, suberic acid, azelaic acid, sebacic acid, fumaric acid, dimethyl fumarate, dimethyl itaconate, cis-1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid, mesaconic acid, a diester or anhydride thereof, and mixtures and combinations thereof. The organic diacid can be present in any suitable or desired amount, in embodiments, from about 25 to about 60 mole percent, or from about 25 to about 52 mole percent, or from about 25 to about 50 mole percent. In embodiments, a second diacid can be selected from the above-described diacids and can be present in an amount of from about 0 to about 25 mole percent of the resin.

The components can be selected in any suitable or desired ratio. In embodiments, the branching monomer can be provided in an amount of from about 0.1 to about 15 mole percent, or from about 1 to about 10 mole percent, or from about 2 to about 5 mole percent, and, in embodiments, a second branching monomer can be selected in any suitable or desired amount, in embodiments, from about 0 to about 10 mole percent, or from about 0.1 to about 10 mole percent of the robust resin.

For forming crystalline polyester, one or more polyacid branching monomers as described above can be reacted with a diol in the presence of an optional catalyst and a further organic diacid or diester as described above. The components can be selected in any suitable or desired ratio. In embodiments, the branching monomer can be provided in an amount of from about 0.1 to about 15 mole percent, or from about 1 to about 10 mole percent, or from about 2 to about 5 mole percent, and, in embodiments, a second branching monomer can be selected in any suitable or desired amount, in embodiments, from about 0 to about 10 mole percent, or from about 0.1 to about 10 mole percent of the robust resin.

In certain embodiments, the toner herein contains a robust resin as described herein wherein the robust resin is an amorphous resin.

Examples of diacids or diesters suitable for use in forming the resin herein include vinyl diacids or vinyl diesters used for the preparation of amorphous polyester resins including dicarboxylic acids or diesters such as terephthalic acid, phthalic acid, isophthalic acid, fumaric acid, trimellitic acid, dimethyl fumarate, dimethyl itaconate, cis-1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, lutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethladipate, dimethyl dodecylsuccinate, and mixtures and combinations thereof.

The organic diacid or diester may be present in any suitable or desired amount, such as from about 35 to about 60 mole percent of the resin, or from about 42 to about 52 mole percent of the resin, or from about 45 to about 50 mole percent of the resin.

Examples of diols which may be used to prepared the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene, and mixtures and combinations thereof.

The organic diol can be present in any suitable or desired amount, such as from about 35 to about 60 mole percent of the resin, or from about 42 to about 55 mole percent of the resin, or from about 45 to about 53 mole percent of the resin.

Polycondensation Catalyst.

In embodiments, polycondensation catalysts may be used in forming the polyesters. Polycondensation catalysts which may be utilized for either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, and mixtures and combinations thereof. Such catalysts may be utilized in any suitable or desired amount, such as from about 0.01 mole percent to about 5 mole percent based on the starting diacid or diester used to generate the polyester resin.

As noted, the robust resin can be prepared by any suitable or desired method. For example, one or more branching monomers as described herein can be combined with one or more acid or diester components in the optional presence of a catalyst, heated, optionally in an inert atmosphere, to condense the monomers into prepolymers. To this mixture can be added one or more diacids or diesters, optionally additional catalyst, optionally a radical inhibitor, with heating, optionally under inert atmosphere, to form the desired final robust branched resin (polyester).

Heating can be to any suitable or desired temperature, such as from about 140° C. to about 250° C., or about 160° C. to about 230° C., or about 180° C. to about 220° C.

Any suitable inert atmosphere conditions can be selected, such as under nitrogen purge.

If desired, a radical inhibitor can be used. Any suitable or desired radical inhibitor can be selected, such as hydroquinone, toluhydroquinone, 2,5-DI-tert-butylhydroquinone, and mixtures and combinations thereof. The radical inhibitor can be present in any suitable or desire amount, such as from about 0.01 to about 1.0, about 0.02 to about 0.5, or from about 0.05 to about 0.2 weight percent of the total reactor charge

In certain embodiments, 12.6 grams glycoxylated bisphenol-A branching monomer can be combined with 273.1 grams propoxylated bisphenol-A and 140.7 grams ethoxylated bisphenol-A, 130.4 grams terephthalic acid, and 3 grams of (butyl(hydroxy)stannanone) tin catalyst into a reactor and heated to 260° C. under nitrogen purge in order to condense the monomers into pre-polymers. To this mixture can be added 92.1 grams dodecylsuccinic anhydride monomer and 22.1 grams fumaric acid monomer, 1 gram additional (butyl(hydroxy)stannanone) tin catalyst, and 1 gram of hydroquinone (a radical inhibitor). The monomers can be heated to 205° C. with nitrogen purge to condense and form the desired final robust branched resin (polyester).

Neutralizing Agent.

In embodiments, the robust resin herein can be pre-blended with a weak base or neutralizing agent. In embodiments, the base can be a solid, thereby eliminating the need to use a solution, which avoids the risks and difficulties associated with pumping a solution.

In embodiments, the robust resin herein and the neutralizing agent can be simultaneously fed through a co-feeding process which may accurately control the feed rate of the neutralizing agent and the robust resin into an extruder and which may then be melt mixed followed by emulsification.

In embodiments, the neutralizing agent can be used to neutralize acid groups in the resins. Any suitable or desired neutralizing agent can be selected. In embodiments, the neutralizing agent can be selected from the group consisting of ammonium hydroxide, potassium hydroxide, sodium hydroxide, sodium carbonate, sodium bicarbonate, lithium hydroxide, potassium carbonate, and mixtures and combinations thereof.

The neutralizing agent can be used as a solid, such as sodium hydroxide flakes, etc., in an amount of from about 0.001% to about 50% by weight, or from about 0.01% to about 25% by weight, or from about 0.1% to about 5% by weight, based on the weight of the resin.

In certain embodiments, the neutralizing agent is a solid neutralizing agent selected from the group consisting of ammonium hydroxide flakes, potassium hydroxide flakes, sodium hydroxide flakes, sodium carbonate flakes, sodium bicarbonate flakes, lithium hydroxide flakes, potassium carbonate flakes, organoamines, and mixtures and combinations thereof.

In embodiments, the neutralizing agent can be sodium hydroxide flakes. In embodiments, the surfactant used can be an aqueous solution of alkyldiphenyloxide disulfonate to ensure that proper resin neutralization occurs when using sodium hydroxide flakes and leads to a high quality latex with low coarse content. Alternatively, a solid surfactant of sodium dodecyl benzene sulfonate can be used and co-fed with the resin into the extruder feed hopper eliminating the need to use a surfactant solution thereby providing a simplified and efficient process.

An emulsion formed in accordance with the present process can also include a small amount of water, in embodiments, deionized water, in any suitable or desired amount, such as from about 20% to about 300%, or from about 30% to about 150%, by weight of the resin, at temperatures that melt or soften the resin, such as from about 40° C. to about 140° C., or from about 60° C. to about 100° C.

Surfactant.

The process herein can include adding a surfactant to the resin before or during the melt mixing, at an elevated temperature. In embodiments, the surfactant can be added prior to melt-mixing the resin at an elevated temperature. In embodiments, a solid surfactant can be co-fed with the resin and the neutralizing agent into the extruder. In embodiments, a solid surfactant can be added to the resin and neutralizing agent to form a pre-blend mixture prior to melt mixing. Where surfactants are used, the resin emulsion may include one, two, or more surfactants. The surfactant can be selected from ionic surfactants and nonionic surfactants. Ionic surfactants can include anionic surfactants and cationic surfactants. The surfactant can be added as a solid or as a solution in any suitable or desired amount, such as a solution with a concentration of about 5% to about 80% by weight, or from about 10% to about 60% by weight. In embodiments, the surfactant can be present in an amount of from about 0.01% to about 20%, or from about 0.1% to about 16% , or from about 1% to about 14%, by weight of the resin.

Any suitable or desired surfactant can be selected for use herein. In embodiments, the surfactant can be selected from the group consisting of sodium dodecylsulfates, sodium dodecylbenzene sulfonates, sodium dodecylnaphthalene sulfate, dialkyl benzenealkyl sulfates, dialkylbenzenealkyl sulfonates, abitic acid, alkyl diphenyloxide disulfonates, branched sodium dodecyl benzene sulfonates, polyvinyl alcohol, polyacrylic acid, methalose, methyl cellulose, ethyl cellulose, propyl cellulose, hydroxylethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleylether, polyoxyethylene sorbitan monolaurate, polyoxyethylene stearyl ether, polyoxyethylene nonylphenyl ether, dialkylphenoxy poly(ethyleneoxy)ethanol, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, C₁₂ trimethyl ammonium bromide, C₁₅ trimethyl ammonium bromide, C₁₇ trimethyl ammonium bromide, dodecyl benzyl triethyl ammonium chloride, cetyl pyridinium bromide, and mixtures and combinations thereof.

As noted above, the process herein can include melt mixing at an elevated temperature a mixture containing the robust resin described herein, a solid or aqueous surfactant, and a solid neutralizing agent, wherein an organic solvent is not used in the process, to form a latex emulsion wherein the robust resin is resistant to degradation. In embodiments, the robust resin and the neutralizing agent can be pre-blended prior to melt mixing. In embodiments, the robust resin can be co-fed into a screw feeder with the solid neutralizing agent.

Additional Resin.

More than one resin can be used to form the latex herein. The robust resin can be an amorphous resin, a crystalline resin, or a combination thereof. In certain embodiments, the toner herein contains a robust resin as described herein wherein the robust resin is an amorphous resin. In embodiments, the robust resin can be an amorphous resin and the elevated temperature can be a temperature above the glass transition temperature of the amorphous resin. In other embodiments, the toner herein can contain the present robust resin and further contain a crystalline resin and the elevated temperature can be a temperature above the melting point of the crystalline resin. In further embodiments, the robust resin can be a mixture of amorphous and crystalline resins and the temperature can be above the glass transition temperature of the mixture.

In embodiments, the surfactant can be added to the one or more components of the resin composition before during, or after melt-mixing. In embodiments, the surfactant can be added before, during, or after the addition of the neutralizing agent. In embodiments, the surfactant can be added prior to the addition of the neutralizing gent. In embodiments, a solid surfactant can be added to the pre-blend mixture prior to melt mixing.

The elevated temperature can be any suitable or desired temperature, in embodiments, from about 30° C. to about 300° C., or from about 50° C. to about 200° C., or from about 70° C. to about 150° C.

Melt mixing can be conducted in an extruder, such as a twin screw extruder, a kneader, such as a Haake mixer, a batch reactor, or any other device capable of intimately mixing viscous materials to create near homogenous mixtures.

Optionally, stirring can be used to enhance formation of the latex. Any suitable stirring device can be used. In embodiments, stiffing may be at from about 10 revolutions per minute (rpm) to about 5,000 rpm, or from about 20 rpm to about 2,000 rpm, or from about 50 rpm to about 1,000 rpm. The stiffing need not be at a constant speed, but may be varied. For example, as the heating of the mixture because more uniform, the stirring rate can be increased.

Once the robust resin, neutralizing agent, and surfactant are melt mixed, the mixture can be contacted with water to form a latex emulsion. Water can be added so as to form a latex with any suitable or desired solids content, such as from about 5% to about 50% or from about 10% to about 40%. While higher water temperatures can accelerate the dissolution process, latexes can be formed at temperatures as low as room temperature. In embodiments, water temperatures can be from about 40° C. to about 110° C. or from about 50° C. to about 100° C.

Contact between the water and the robust resin mixture can be by any suitable manner such as in a vessel or continuous conduit or in a packed bed. The process described in U.S. Patent Publication 2011/0028620A1, which is hereby incorporated by reference herein in its entirety, can be used for the robust resin latex herein.

The latex herein can be prepared in an extruder and the product exiting the extruder can include a stream of latex that is collected and stored for later use in the present aggregation/coalescence toner process.

The particle size of the latex emulsion formed can be controlled by the concentration ratio of surfactant and neutralizing agent to robust polyester resin. The solids concentration of the latex can be controlled by the ratio of the robust resin mixture to water.

The emulsified resin particles in the aqueous medium can have a size of from about 1,500 nanometers or less, such as from about 10 nanometers to about 1,200 nanometers, or from about 30 nanometers to about 1,000 nanometers.

The particle size distribution of a latex herein can be from about 60 nanometers to about 300 nanometers, or from about 125 nanometers to about 200 nanometers.

The coarse content of the latex herein can be from about 0 to about 5% of the solids content of the latex. Coarse content meaning any solid material being retained by a 20 μm sieve.

The solids content of the latex herein can be from about 5% to about 80% or from about 30% to about 40% by weight based on the total weight of the latex.

The latex emulsion containing the robust resin herein may be utilized to form a toner by any method within the purview of those skilled in the art. The latex emulsion may be contacted with a colorant, optionally in the form of a colorant dispersion, and other additives to form a toner by a suitable process, in embodiments, an emulsion aggregation and coalescence process. In embodiments, the toner processes herein employ the latex emulsions herein to produce particle sizes that are suitable for emulsion aggregation ultra low melt processes.

In embodiments, a toner process herein comprises providing an aqueous emulsion comprising a branched polyester suitable for use in solvent-free emulsification, the branched polyester having a first original weight average molecular weight before undergoing solvent-free emulsification and a second weight average molecular weight after undergoing solvent-free emulsification, wherein the branched polyester has a structure that limits degradation of the polyester during solvent-free emulsification to less than about 20 percent of the first original weight average molecular weight, wherein the polyester comprises a compound of the formula as described herein above; and

aggregating toner particles from the aqueous emulsion.

Optionally, the toner process further comprises coalescing the aggregated toner particles.

In embodiments, the toner further comprises including a wax; and optionally, a colorant.

In embodiments, the toner process further comprises wherein the aggregated toner particles form a core, and further comprise, during aggregation, adding additional emulsion to form a shell over the core. In certain embodiments, the additional emulsion forming the shell is the same material as the emulsion forming the core. In other embodiments, the additional emulsion forming the shell can be different from the material forming the toner core.

In other embodiments, the toner herein can be formed by a process comprising homogenizing the robust resin emulsion with a surfactant, an optional colorant, and an optional wax, and an optional coagulant to form a homogenized toner slurry comprising pre-aggregated particles at room temperature; heating the slurry to form aggregated toner particles; optionally freezing the toner slurry once at the desired aggregated particle size; and further heating the aggregated particles in the slurry to coalesce the aggregated particles into toner particles.

Heating to form aggregated toner particles may be to any suitable or desired temperature for any suitable or desired time. In embodiments heating to form aggregated toner particles may be to a temperature below the Tg of the latex, in embodiments to from about 30° C. to about 70° C. or to about 40° C. to about 65° C., for a period of time of from about 0.2 hour to about 6 hours, from about 0.3 hour to about 5 hours, in embodiments, resulting in toner aggregates of from about 3 microns to about 15 microns in volume average diameter, in embodiments of from about 4 microns to about 8 microns in volume average diameter, although not limited.

Freezing the toner slurry to stop particle growth once the desired aggregated particle size is achieved can be by any suitable or desired method. In embodiments, the mixture is cooled in a cooling or freezing step. In embodiments, the mixture is pH adjusted, such as by freezing the aggregation of the particles with a buffer solution having a pH of about 7 to about 12, over a period of from about 1 minute to about 1 hour, or to about 8 hours or from about 2 minutes to about 30 minutes. In embodiments, cooling a coalesced toner slurry includes quenching by adding a cooling medium such as, for example, ice, dry ice and the like, to effect rapid cooling to a temperature of from about 20° C. to about 40° C. or from about 22° C. to about 30° C.

Coalescing the aggregated particles into toner particles can be by any suitable or desired method. In embodiments, coalescing comprises further heating the aggregated particles in the slurry to coalesce the aggregated particles into toner particles. In embodiments, the aggregate suspension may be heated to a temperature at or above the Tg of the latex. Where the particles have a core-shell configuration, heating may be above the Tg of the first latex used to form the core and the Tg of the second latex used to form the shell, to fuse the shell latex with the core latex. In embodiments, the aggregate suspension may be heated to a temperature of from about 80° C. to about 120° C. or from about 85° C. to about 98° C., for a period of time from about 1 hour to about 6 hours or from about 2 hours to about 4 hours.

The toner slurry may then be washed. In embodiments, washing may be carried out at a pH of from about 7 to about 12 or from about 9 to about 11 and the washing may be at a temperature of from about 30° C. to about 70° C. or from about 40° C. to about 67° C. The washing may include filtering and reslurrying a filter cake including toner particles in deionized water. The filter cake may be washed one or more times by deionized water, or washed by a single deionized water wash at a pH of about 4 wherein the pH of the slurry is adjusted with an acid, and followed optionally by one or more deionized water washes.

In embodiments, drying may be carried out at a temperature of from about 35° C. to about 75° C. or from about 45° C. to about 60° C. The drying may be continued until the moisture level of the particles is below a set target of about 1% by weight, in embodiments of less than about 0.7% by weight.

Colorants.

As the colorant to be added, various known suitable colorants, such as dyes, pigments, mixtures of dyes, mixtures of pigments, mixtures of dyes and pigments, and the like, may be included in the toner or colorant dispersions herein. The colorant may be included in any suitable or desired amount, in embodiments, the colorant may be included in the toner in an amount of from about 0.1 to about 35 percent by weight of the toner, or from about 1 to about 15 weight percent of the toner, or from about 3 to about 10 percent by weight of the toner.

As examples of suitable colorants, mention may be made of carbon black such as REGAL 330® (Cabot), Carbon Black 5250 and 5750 (Columbian Chemicals), Sunsperse® Carbon Black LHD 9303 (Sun Chemicals); magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX8600™, 8610™; Northern Pigments magnetites, NP604™, NP608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE® 6000, FLEXIVERSE® and AQUATONE® water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC1026™, E.D. TOLUIDINE RED™ and BON RED C™ available from Dominion Color Corporation, Ltd., Toronto, Ontario, NOVAPERM® YELLOW FGL™, HOSTAPERM® PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI-60710, CI Dispersed Red 15, diazo dye identified in the Color Index as CI-26050, CI Solvent Red 19, and the like. Illustrative examples of cyans include copper tetra(octadecyl sulfonamido) phthalocyanine, x-copper phthalocyanine pigment listed in the Color Index as CI-74160, CI Pigment Blue, Pigment Blue 15:3, and Anthrathrene Blue, identified in the Color Index as CI-69810, Special Blue X-2137, and the like. Illustrative examples of yellows are diarylide yellow 3,3-dichlorobenzidene acetoacetanilides, a monoazo pigment identified in the Color Index as CI-12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl® Black A-SF (Miles, Bayer) and Sunsperse® Carbon Black LHD 9303 (Sun Chemicals), and colored dyes such as Neopen® Blue (BASF), Sudan Blue OS (BASF), PV Fast Blue B2G01 (American Hoechst), Sunsperse® Blue BHD 6000 (Sun Chemicals), Irgalite® Blue BCA (Ciba-Geigy), Paliogen® Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen® Orange 3040 (BASF), Ortho® Orange OR 2673 (Paul Uhlich), Paliogen® Yellow 152, 1560 (BASF), Lithol® Fast Yellow 0991K (BASF), Paliotol® Yellow 1840 (BASF), Neopen® Yellow (BASF), Novoperm® Yellow FG 1 (Hoechst), Permanent Yellow YE 0305 (Paul Uhlich), Lumogen® Yellow D0790 (BASF), Sunsperse® Yellow YHD 6001 (Sun Chemicals), Suco-Gelb® L1250 (BASF), Suco-Yellow® D1355 (BASF), Hostaperm® Pink E (American Hoechst), Fanal® Pink D4830 (BASF), Cinquasia® Magenta (DuPont), Lithol® Scarlet D3700 (BASF), Toluidine Red (Aldrich), Scarlet for Thermoplast NSD PS PA (Ugine Kuhlmann of Canada), E.D. Toluidine Red (Aldrich), Lithol® Rubine Toner (Paul Uhlich), Lithol® Scarlet 4440 (BASF), Bon Red C (Dominion Color Company), Royal® Brilliant Red RD-8192 (Paul Uhlich), Oracet® Pink RF (Ciba-Geigy), Paliogen® Red 3871K (BASF), Paliogen® Red 3340 (BASF), Lithol® Fast Scarlet L4300 (BASF), combinations of the foregoing, and the like.

Wax.

Optionally, a wax may also be combined with the robust hybrid resin and optional colorant in forming toner particles. The wax may be provided in a dispersion, which may include a single type of wax or a mixture of two or more different waxes. A single wax may be added to the toner formulations, for example, to improve particular toner properties, such as toner particle shape, presence, and amount of wax on the toner particle surface, charging and/or fusing characteristics, gloss, stripping, offset properties, and the like. Alternatively, a combination of waxes can be added to provide multiple properties to the toner composition.

The wax may be included in any suitable or desired amount. When included, the wax may be present in an amount of, for example, from about 1 weight percent to about 25 weight percent of the toner particles, or from about 5 weight percent to about 20 weight percent of the toner particles.

When a wax dispersion is used, the wax dispersion may include any of the various waxes conventionally used in emulsion aggregation toner compositions. Waxes that may be selected include waxes having, for example, an average molecular weight of from about 500 to about 20,000, or from about 1,000 to about 10,000. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 53™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents. In embodiments, the waxes may be crystalline or non-crystalline.

In embodiments, the wax may be incorporated into the toner in the form of one or more aqueous emulsions or dispersions of solid wax in water, where the solid wax particle size may be in the range of from about 100 to about 300 nanometers.

Coagulants.

Optionally, a coagulant may also be combined with the robust resin, optional colorant, and wax in forming toner particles. Such coagulants may be incorporated into the toner particles during particle aggregation. The coagulant may be present in the toner particles in any suitable or desired amount, such as, exclusive of external additives and on a dry weight basis, in an amount of from about 0 to about 5 weight percent of the toner particles, or from about 0.01 to about 3 weight percent of the toner particles.

Coagulants that may be used include ionic coagulants, such as cationic coagulants. Inorganic cationic coagulants include metal salts, for example, aluminum sulfate, magnesium sulfate, zinc sulfate, potassium aluminum sulfate, calcium acetate, calcium chloride, calcium nitrate, zinc acetate, zinc nitrate, aluminum chloride, and the like.

Examples of organic cationic coagulants include dialkyl benzenealkyl ammonium chloride, lauryl trimethyl ammonium chloride, alkylbenzyl methyl ammonium chloride, alkylbenzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, and mixtures and combinations thereof.

Other suitable coagulants include monovalent metal coagulants, divalent metal coagulants, polyion coagulants, and the like. As used herein, “polyion coagulant” refers to a coagulant that is a salt or oxide, such as a metal salt or metal oxide, formed from a metal species having a valence of at least 3, and desirably at least 4 or 5. Suitable such coagulants include coagulants based on aluminum salts, such as aluminum sulphate and aluminum chlorides, polyaluminum halides such as polyaluminum fluoride and polyaluminum chloride (PAC), polyaluminum silicates such as polyaluminum sulfosilicate (PASS), polyaluminum hydroxide, polyaluminum phosphate, and the like.

Other suitable coagulants include tetraalkyl titinates, dialkyltin oxide, tetraalkyltin oxide hydroxide, dialkyltin oxide hydroxide, aluminum alkoxides, alkylzinc, dialkyl zinc, zinc oxides, stannous oxide, dibutyltin oxide, dibutyltin oxide hydroxide, tetraalkyltin, and the like. Where the coagulant is a polyion coagulant, the coagulant may have any desired number of polyion atoms present. For example, suitable polyaluminum compounds have from about 2 to about 13, or from about 3 to about 8, aluminum ions present in the compound.

Additives.

In embodiments, the toner particles may further contain optional additives as desired or required. For example, the toner may include positive or negative charge control agents, such as in an amount of from about 0.1 to about 10%, or from about 1 to about 3% by weight of the toner. Examples of suitable charge control agents include quaternary ammonium compounds inclusive of alkyl pyridinium halides, bisulfates, alkyl pyridinium compounds, including those disclosed in U.S. Pat. No. 4,298,672, which is hereby incorporated by reference herein in its entirety, organic sulfate and sulfonate compositions, including those discloses in U.S. Pat. No. 4,338,390, which is hereby incorporated by reference herein in its entirety, cetyl pyridinium tetrafluoroborates, distearyl dimethyl ammonium methyl sulfate, aluminum salts such as CONTRON E84™ or E88™ (Orient Chemical Industries, Ltd.), and mixtures and combinations thereof.

There can also be blended with the toner particles external additive particles including flow aid additives, which additives may be present on the surface of the toner particles. Examples of these additives include metal oxides such as titanium oxide, silicon oxide, aluminum oxide, cerium oxide, tin oxide, mixtures thereof, and the like; colloidal and amorphous silicas, such as AEROSIL®, metal salts and metal salts of fatty acids inclusive of zinc stearate, calcium stearate, or long chain alcohols such as UNILIN® 700, and mixtures and combinations thereof.

Silica may be applied to the toner surface for toner flow, tribo enhancement, admix control, improved development and transfer stability, and higher toner blocking temperature. TiO₂ may be applied for improved relative humidity (RH) stability, tribo control, and improved development and transfer stability. Zinc stearate, calcium stearate and/or magnesium stearate may optionally also be used as an external additive for providing lubricating properties, developer conductivity tribo enhancement, enabling higher toner charge and charge stability by increasing the number of contacts between toner an carrier particles. In embodiments, a commercially available zinc stearate known as Zinc Stearate L, available from Ferro Corporation, may be used. The external surface additives may be used with or without a coating.

Each of these external additives may be present in any suitable or desired amount, such as from about 0.1 percent by weight to about 5 percent by weight of the toner, or from about 0.25 percent by weight to about 3 percent by weight of the toner.

Developers.

The toner particles thus obtained may be formulated into a developer composition. The toner particles may be mixed with carrier particles to achieve a two-component developer composition. The toner concentration in the developer may be any suitable or desired concentration, in embodiments, from about 1% to about 25% by weight of the total weight of the developer.

Examples of carrier particles that can be utilized for mixing with the toner include those particles that are capable of triboelectrically obtaining a charge of opposite polarity to that of the toner particles including granular zircon, granular silicon, glass, steel, nickel, ferrites, iron ferrites, silicon dioxide.

The selected carrier particles can be used with or without a coating. The carrier particles may include a core with a coating thereover which may be formed from a mixture of polymers that are not in close proximity thereto in the triboelectric series. The coating may include fluoropolymers, terpolymers of styrene, methyl methacrylate, and/or silanes, although not limited.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

The following materials were used in the Examples:

Dowfax® 2A1 Surfactant, alkyldiphenyloxide disulfonate surfactant, available from The Dow Chemical Company.

Poly(co-propoxylated bisphenol co-terephthalate co-fumarate, amorphous resin.

Poly(co-propoxylated bisphenol co-ethoxylated bisphenol co-terephthalate), amorphous resin.

Cyan pigment.

Poly(nonylene-decanoate), crystalline resin.

Poly(co-propoxylated bisphenol co-glycoxylated bisphenol co-ethoxylated co-terephthalate co-fumarate), hybrid amorphous resin.

### Example 1

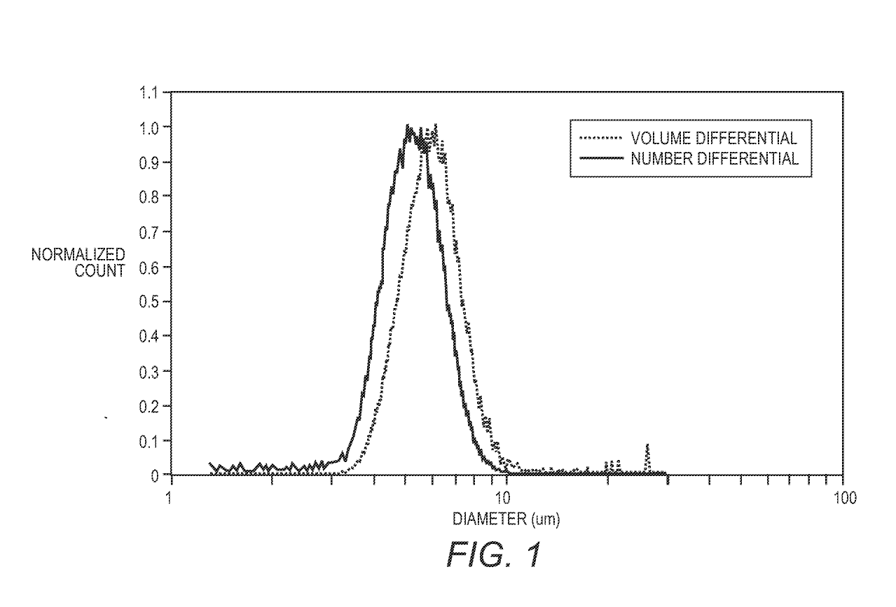

A comparative cyan polyester emulsion aggregation toner was prepared at the 2 Liter Bench scale (150 grams dry theoretical toner). Two amorphous emulsions each containing 2 parts Dowfax® 2A1 surfactant per part of resin were mixed, the first amorphous emulsion in a quantity of 109 grams with a solids content of 35% also containing 109 grams poly(co-propoxylated bisphenol co-terephthalate co-fumarate amorphous resin and the second amorphous emulsion in a quantify of 114 grams poly(co-propoxylated bisphenol co-ethoxylated bisphenol co-terephthalate) amorphous resin. To this mixture was added 30 grams of a crystalline poly(nonylene-decanoate) emulsion at 35% solids content containing 2 parts per hundred) Dowfax® 2A1 surfactant per hundred parts of resin, 46 grams polyethylene wax (Accumelt® R3910, IGI Waxes) and 53 grams cyan pigment dispersion (Cyan 15:3 Dispersion) and mixed, then pH adjusted to 4.2 using 0.3M nitric acid. The slurry was then homogenized for a total of 5 minutes at 3000-4000 rpm while adding in 2.69 grams aluminum sulphate coagulant mixed with 36 grams deionized (DI) water. The slurry was then transferred to the 2 L Buchi and set mixing at 460 rpm. The slurry was then aggregated at a batch temperature of 45° C. During aggregation, a shell comprised of the same amorphous emulsions as in the core was added and then the batch was further heated to 45° C. to achieve the targeted particle size. Once at the target particle size the pH was adjusted using sodium hydroxide (NaOH), ethylenediaminetetraacetic acid (EDTA) and then again with NaOH to freeze the aggregation. The process proceeds with the reactor temperature (Tr) being increased to achieve 85° C., at the desired temperature with the pH adjusting to 7.15 using 0.3M nitric acid where the particles begin to coalesce. After about two and a half hours particles achieve >0.962 and are quench cooled in ice batch. Final toner particle size, GSDv and GSDn were 5.89/1.22/1.23 respectively. Fines (1-4 microns), coarse (>16 microns) and circularity were 10.74%, 0.73% and 0.972. FIG. 1 illustrates normalized count (y axis) versus diameter (micrometers, x axis), volume differential, and number differential, for the particles of comparative Example 1.

### Example 2

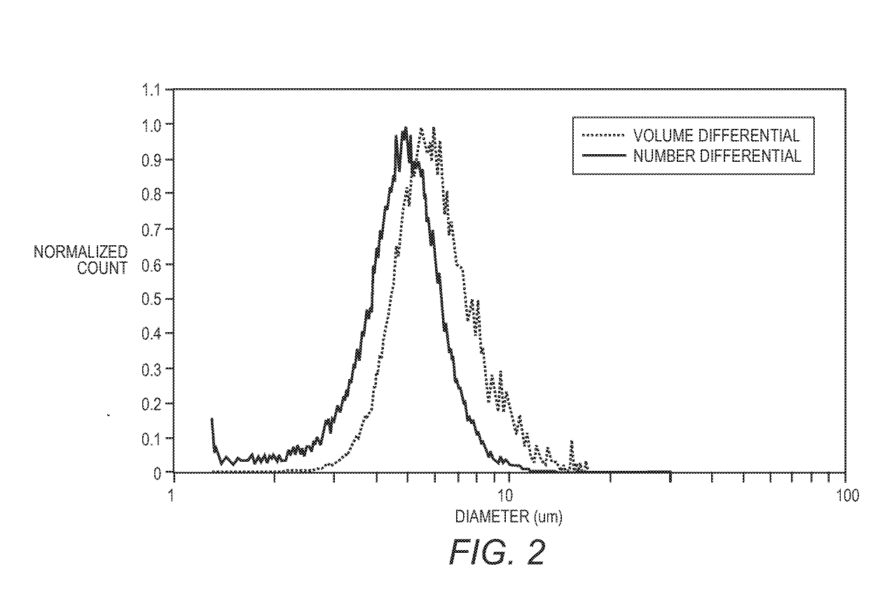

A cyan polyester toner in accordance with the present disclosure was prepared at the 2 Liter Bench scale (150 grams dry theoretical toner). An amorphous emulsion comprising 2 parts Dowfax® 2A1 surfactant per part of resin and 388 grams of a robust resin dispersion of the present disclosure being poly(co-propoxylated bisphenol co-glycoxylated bisphenol co-ethoxylated co-terephthalate co-fumarate) at 20 weight % solids was prepared and mixed with 30 grams of a crystalline poly(nonylene-decanoate) at 35% solids content emulsion containing 2 parts per hundred) Dowfax® 2A1 surfactant per hundred parts of resin, 46 grams polyethylene wax (Accumelt® R3910, IGI Waxes) and 53 grams pigment dispersion (Cyan 15:3 Dispersion) and mixed, then pH adjusted to 4.2 using 0.3M nitric acid. The slurry was then homogenized for a total of 5 minutes at 3000-4000 rpm while adding in 2.69 grams of aluminum sulphate coagulant mixed with 36 grams DI water. The slurry was then transferred to the 2 L Buchi and set mixing at 460 rpm. The slurry was then aggregated at a batch temperature of 41° C. During aggregation, a shell comprised of the same amorphous emulsion as in the core was added and then the batch was further heated at 41° C. to achieve the targeted particle size. Once at the target particle size the pH was adjusted using NaOH, EDTA and then again with NaOH to freeze the aggregation. The process proceeded with the reactor temperature (Tr) being increased to achieve 70° C., at the desired temperature the pH is adjusting to 7.10 using sodium acetate buffer where the particles begin to coalesce. After about three and a half hours particles achieve >0.962 and are cooled by lowering the reactor temperature rather that by being quenched as in the standard batch. Final toner particle size, GSDv and GSDn were 5.77/1.34/1.34 respectively. Fines (1-4 microns), coarse (>16 microns) and circularity were 24.66%, 0.10% and 0.963. FIG. 2 illustrates normalized count (y axis) versus diameter (micrometers, x axis), volume differential, and number differential, for the particles of Example 2.

TABLE

| | Type of | Particle | | |
|---|---|---|---|---|
| | Amorphous | D50/GSDv/ | Particle | |
| | Latex | GSDn | Circularity | Remarks |
| Example 1 | Two | 5.9/1.22/1.23 | 0.92 | Control of toner |
| | Amorphous | | | size, GSD, and |
| | Latexes | | | circularity |
| Example 2 | Robust | 5.8/1.34/1.34 | 0.963 | Lower coalescence |
| | Hybrid Resin | | | temperature at |
| | Latex | | | 70° C. instead of |
| | | | | 85° C. due to the |
| | | | | properties of the |
| | | | | hybrid resin |

The toner herein includes a robust hybrid resin that can reduce the number of amorphous resins used in emulsion aggregation toners, in embodiments from two amorphous resins to one amorphous resin by combining the properties of the previously used two amorphous resins. In embodiments, the present disclosure eliminates the need to handle two different amorphous material streams for toner making. The present toner including the single robust hybrid amorphous resin design provides lower toner cost by simplifying toner design thereby providing ease of latex and toner preparation and further cost reduction by enabling use of solvent-free emulsification technology.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A toner comprising:
a branched polyester having a first original weight average molecular weight before undergoing solvent-free emulsification and a second weight average molecular weight after undergoing solvent-free emulsification, wherein the branched polyester has a structure that limits degradation of the polyester during solvent-free emulsification to less than about 20 percent of the first original weight average molecular weight, wherein the polyester comprises a compound of the formula: 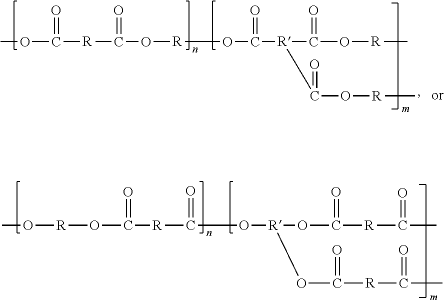
wherein R is an alkylene group, and wherein the alkylene group can be selected from linear and branched, saturated and unsaturated, cyclic and acyclic, and substituted and unsubstituted alkylene groups, and wherein heteroatoms either may or may not be present in the alkylene group;
wherein R′ is an alkylene group, and wherein the alkylene group can be selected from linear and branched, saturated and unsaturated, cyclic and acyclic, and substituted and unsubstituted alkylene groups, and wherein heteroatoms either may or may not be present in the alkylene group;
wherein all carbonyl carbons adjacent to R′ are separated by at least two atoms if the two atoms are separated by a single bond; or
wherein all carbonyl carbons adjacent to R′ are separated by at least 3 atoms covalently linked in series;
wherein m is an integer from about 1 to about 1,000; and
wherein n is an integer from about 1 to about 1,000;
an optional wax; and
an optional colorant.

2. The toner of claim 1, wherein the branching of the branched polyester is achieved by preparing the branched polyester with an acid monomer having three or more carboxylic acid groups.

3. The toner of claim 1, wherein the branching of the branched polyester is achieved by preparing the branched polyester with an acid monomer selected from the group consisting of trimesic acid, biphenyl-3,4′,5-tricarboxylic acid, 1,3,5-trimethylcyclohexane-1,3,5-tricarboxylic acid, cyclohexane-1,3,5-tricarboxylic acid, biphenyl-3,3′,5,5′-tetracarboxylic acid, citric acid, tricarboxylic acid, butanetricarboxylic acid, nitrilotriacetic acid, and mixtures and combinations thereof.

4. The toner of claim 1, wherein the branched polyester contains acid-derived branching sites that limit or prevent altogether degradation of the polyester during solvent-free emulsification processes;
wherein the branched polyester contains alcohol-derived branching sites that limit or prevent altogether degradation of the polyester during solvent-free emulsification processes; or
wherein the branched polyester contains a combination of acid-derived branching sites and alcohol-derived branching sites that limit or prevent altogether degradation of the polyester during solvent-free emulsification processes.

5. The toner of claim 1, wherein the branched polyester contains branching sites derived from an alcohol branching monomer having three or more hydroxyl groups.

6. The toner of claim 1, wherein the branched polyester contains branching sites derived from an alcohol branching monomer selected from the group consisting of glycoxylated bisphenol-A, glycerine-modified bisphenol-A derivatives, glycerine, pentaerythritol, trimethylolpropane, mannitol, sorbitol, xylitol, glucose, fructose, sucrose, and mixtures and combinations thereof.

7. The toner of claim 1, wherein the branched polyester contains a portion derived from a diacid or diester.

8. The toner of claim 1, wherein the branched polyester contains a portion derived from a diacid or diester selected from the group consisting of terephthalic acid, phthalic acid, isophthalic acid, fumaric acid, trimellitic acid, dimethylfumarate, dimethylitaconate, cis-1,4-diacetoxy-2-butene, diethyl fumarate, diethyl maleate, maleic acid, succinic acid, itaconic acid, succinic anhydride, dodecylsuccinic acid, dodecylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and mixtures and combinations thereof.

9. The toner of claim 1, wherein the branched polyester is an amorphous polyester.

10. The toner of claim 1, wherein the toner contains a single resin comprising the branched polyester.

11. The toner of claim 1, further comprising:
a crystalline polyester.

12. The toner of claim 1, wherein the branched polyester is an amorphous polyester; and
wherein the toner further comprises a crystalline polyester.

13. A developer comprising the toner of claim 1, and
a carrier.

14. A toner process comprising:
providing an aqueous emulsion comprising a branched polyester suitable for use in solvent-free emulsification, the branched polyester having a first original weight average molecular weight before undergoing solvent-free emulsification and a second weight average molecular weight after undergoing solvent-free emulsification, wherein the branched polyester has a structure that limits degradation of the polyester during solvent-free emulsification to less than about 20 percent of the first original weight average molecular weight, wherein the polyester comprises a compound of the formula: 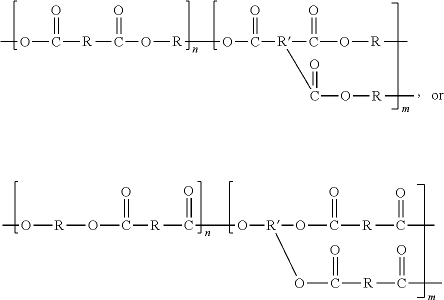
wherein R is an alkylene group, and wherein the alkylene group can be selected from linear and branched, saturated and unsaturated, cyclic and acyclic, and substituted and unsubstituted alkylene groups, and wherein heteroatoms either may or may not be present in the alkylene group;
wherein R′ is an alkylene group, and wherein the alkylene group can be selected from linear and branched, saturated and unsaturated, cyclic and acyclic, and substituted and unsubstituted alkylene groups, and wherein heteroatoms either may or may not be present in the alkylene group;
wherein all carbonyl carbons adjacent to R′ are separated by at least two atoms if the two atoms are separated by a single bond; or
wherein all carbonyl carbons adjacent to R′ are separated by at least 3 atoms covalently linked in series;
wherein m is an integer from about 1 to about 1,000; and
wherein n is an integer from about 1 to about 1,000; and
aggregating toner particles from the aqueous emulsion.

15. The toner process of claim 14, further comprising:
coalescing the aggregated toner particles.

16. The toner process of claim 14, further comprising:
including a wax; and
optionally, a colorant.

17. The toner process of claim 14, wherein the aggregated toner particles form a core, further comprising:
during aggregation, adding additional emulsion to form a shell over the core.

18. The toner process of claim 14, wherein the aggregated toner particles form a core, further comprising:
during aggregation, adding additional emulsion to form a shell over the core, wherein the additional emulsion forming the shell is the same material as the emulsion forming the core.

19. The toner process of claim 14, wherein the branched polyester contains acid-derived branching sites that limit or prevent altogether degradation of the polyester during solvent-free emulsification processes;
wherein the branched polyester contains alcohol-derived branching sites that limit or prevent altogether degradation of the polyester during solvent-free emulsification processes; or
wherein the branched polyester contains a combination of acid-derived branching sites and alcohol-derived branching sites that limit or prevent altogether degradation of the polyester during solvent-free emulsification processes.

20. The toner process of claim 14, wherein the branched polyester is an amorphous polyester; and
wherein the toner further comprises a crystalline polyester.
